(19) United States
(12) Patent Application Publication
(10) Pub. No.: US 2014/0252984 A1
(43) Pub. Date: Sep. 11, 2014

(54) LED BACKLIGHT DRIVING CIRCUIT, LCD DEVICE, AND DRIVING CIRCUIT

(71) Applicants: Hua Zhang, Shenzhen (CN); Fei Li, Shenzhen (CN)

(72) Inventors: Hua Zhang, Shenzhen (CN); Fei Li, Shenzhen (CN)

(73) Assignee: SHENZHEN CHIINA STAR OPTOELECTRONICS TECHNOLOGY CO LTD., Shenzhen (CN)

(21) Appl. No.: 13/880,077

(22) PCT Filed: Mar. 15, 2013
(86) PCT No.: PCT/CN2013/072705

§ 371 Date: Apr. 18, 2013

(30) Foreign Application Priority Data
Mar. 7, 2013 (CN) 201310073555.4

(51) Int. Cl. H05B 33/08

(52) U.S. Cl. CPC H05B 33/0842
USPC 315/294

(57) ABSTRACT

The present disclosure provides a light emitting diode (LED) backlight driving circuit, a liquid crystal display (LCD) device, and a driving circuit. The LED backlight driving circuit includes a timing control module, an LED lightbar, and a driver module coupled with an output end of the LED lightbar. The driver module includes at least one constant current driver chip driving the LED lightbar to display. The timing control module successively outputs a driving signal to the constant current driver chip. The driving signal includes data units which are arranged in sequence, and each data unit storing a current duty and a phase delay of one LED lightbar. The constant current driver chip directly reads data of a corresponding data unit and drives the LED lightbar to display.

### TECHNICAL FIELD

The present disclosure relates to the field of liquid crystal displays (LCDs), and more particularly to a light emitting diode (LED) backlight driving circuit, an LCD device, and a driving circuit.

### BACKGROUND

At present, typical shutter glass three-dimensional (3D) liquid crystal display (LCD) TVs on a market use a serial peripheral interface (SPI) data transmission interface mode, to control a light emitting diode (LED) backlight driving circuit. As shown in FIG. 1, in the SPI mode, a current duty and a phase delay of all LED lightbars are coded in an output data signal (SDA) in sequence and are transmitted to a constant current driver chip. The constant current driver chip decodes data of the current duty and the phase delay and sends the data to a corresponding LED lightbar through a chip select signal so that the constant current driver chip drives the LED backlight. In the SPI mode, large amounts of data are processed by the constant current driver chip, and a large capacity memory system is needed to store the data, thus increasing costs.

### SUMMARY

In view of the above-described technical problems, the aim of the present disclosure is to provide a low-cost light emitting diode (LED) backlight driving circuit, a liquid crystal display (LCD) device, and a driving circuit.

The aim of the present disclosure is achieved by the following technical scheme:

An LED backlight driving circuit comprises a timing control module, an LED lightbar, and a driver module coupled with an output end of the LED lightbar. The driver module comprises at least one constant current driver chip driving the LED lightbar to display. The timing control module successively outputs a driving signal to the constant current driver chip. The driving signal comprises data units which are arranged in sequence, and each data unit storing a current duty and a phase delay of one LED lightbar. The constant current driver chip directly reads data of a corresponding data unit and then drives the LED lightbar to display.

Furthermore, the constant current driver chip is configured with a signal input pin and a signal output pin. The timing control module is configured with a first signal line and a second signal line. The driver module comprises at least two constant current driver chips, and the constant current driver chips are connected in series. The signal input pin of each constant current driver chip is connected to the signal output pin of a former constant current driver chip or the first signal line. The signal output pin of each constant current driver chip is connected to the signal input pin of next constant current driver chip or the second signal line. This is a method of connecting a plurality of constant current driver chips in series. A serial lighting interface (SLI) data transmission interface mode is used between the timing control module and the constant current driver chip, and the current duty and phase delay of each LED lightbar are transmitted to the constant current driver chip corresponding to each LED lightbar in accordance with the preset order only by performing simple one-way data transmission. The method allows for flexible adjustment of a number of the data unit in accordance with a number of the LED lightbar, simple data format, and high generality.

Furthermore, the driver module comprises four constant current driver chips. This is a specific method of connecting a plurality of constant current driver chips in series.

Furthermore, each constant current driver chip is connected to two LED lightbars. The driving signal further comprises a data packet, and each data packet comprises data units corresponding to two adjacent LED lightbars. In the method, the current duty and phase delay of each LED lightbar are transmitted to each LED lightbar in accordance with the preset order by a two-channel constant current driver chip, only the data of two adjacent LED lightbars are put in one data packet. Corresponding number of two-channel constant current driver chips are collocated in accordance with the number of the LED lightbars, and then the LED backlight driven under three-dimensional (3D) pattern is achieved.

Furthermore, the constant current driver chip is configured with a signal input pin and a signal output pin. The timing control module is configured with a first signal line and a second signal line. The first signal line is coupled with the signal input pin of the constant current driver chip. The second signal line is coupled with the signal output pin of the constant current driver chip. This is an embodiment of using one constant current driver chip.

An LCD device comprises an LED backlight driving circuit of the present disclosure.

A driving method of the LED backlight driving circuit of the present disclosure comprises steps:

A: generating a driving signal by a timing control module, the driving signal comprises data units which are arranged in sequence, and each data unit storing a current duty and a phase delay of one LED lightbar; and

B: directly reading the current duty and phase delay of a corresponding data unit by the constant current driver chip of the driver module and then driving the LED lightbars to display by the constant current driver chip.

Furthermore, in the step A, the driving signal comprises at least one data packet, and each data packet comprises data units corresponding to two adjacent LED lightbars.

Furthermore, in the step B, each constant current driver chip is connected to two LED lightbars. In the method, the current duty and phase delay of each LED lightbar are transmitted to each LED lightbar in accordance with the preset order by a two-channel constant current driver chip, only data of two adjacent LED lightbars are put in one data packet. Corresponding number of two-channel constant current driver chips are collocated in accordance with the number of the LED lightbars, and then the LED backlight driven under 3D pattern is achieved.

Furthermore, in the step B, the driver module comprises at least two constant current driver chips, and the driving signal is transmitted to the constant current driver chip arranged in the final position from the constant current driver chip arranged in a beginning position in sequence. Each constant current driver chips reads the current duty and phase delay of the data unit respectively corresponding to the constant current driver chip, and then drives the LED lightbar to display. This is a method of connecting a plurality of constant current driver chips in series. An SLI data transmission interface mode is used between the timing control module and the constant current driver chip, and the current duty and phase delay of each LED lightbar are transmitted to the constant current driver chip corresponding to each LED lightbar in accordance with the preset order only by performing simple one-way data transmission. The method allows for flexible adjustment of the number of the data unit in accordance with the number of the LED lightbar, simple data format, and high generality.

Furthermore, in the step B, after all of the constant current driver chips receive the driving signal, the constant current driver chips drive the LED lightbars to display in accordance with the current duty and phase delay of respective data unit. After reading the driving signal, all of the constant current driver chips drive together the LED lightbar to display, and all of the constant current driver chips achieve the data of the phase delay under same time benchmark, and all of the constant current driver chips separately drive respective LED lightbar to display after achieving the preset phase delay. Thus, the phase delay between different LED lightbars may not be affected by data transmission delay, thereby having great control accuracy, improving display effect, and increased three-dimensional image display qualities.

In the present disclosure, because the driving signal is divided into data units which are arranged in sequence, each data unit storing the current duty and phase delay of one LED lightbar, namely data of a first LED lightbar is arranged in front of all the data of the LED lightbar when coding the driving signal, data of the current duty and phase delay of following LED lightbars are arranged in sequence, the constant current driver chips of the driver module may directly read the data of the current duty and phase delay, which belong to the data unit of the constant current driver chip, from the driving signals. Thus, the data of the current duty and the phase delay are transmitted to a corresponding chip channel in sequence without storing a large number of driving signals in advance and following complicated operations such as chip selection, decoding and the like, data storage space is reduced, and data processing mode is simplified, thereby saving hardware cost and design and development costs. In addition, because the constant current driver chips may control the LED lightbar by directly reading the driving signal, a plurality of same constant current driver chips are connected in series in accordance with a number of the LED lightbar, and commonality of material is increased.

### BRIEF DESCRIPTION OF FIGURES

FIG. 1 is a schematic diagram of a typical light emitting diode (LED) backlight driving circuit;

FIG. 2 is a schematic diagram of an LED backlight driving circuit of the present disclosure;

FIG. 3 is a schematic diagram of a circuit of a first example of the present disclosure; and

FIG. 4 is a schematic diagram of a method of a second example of the present disclosure.

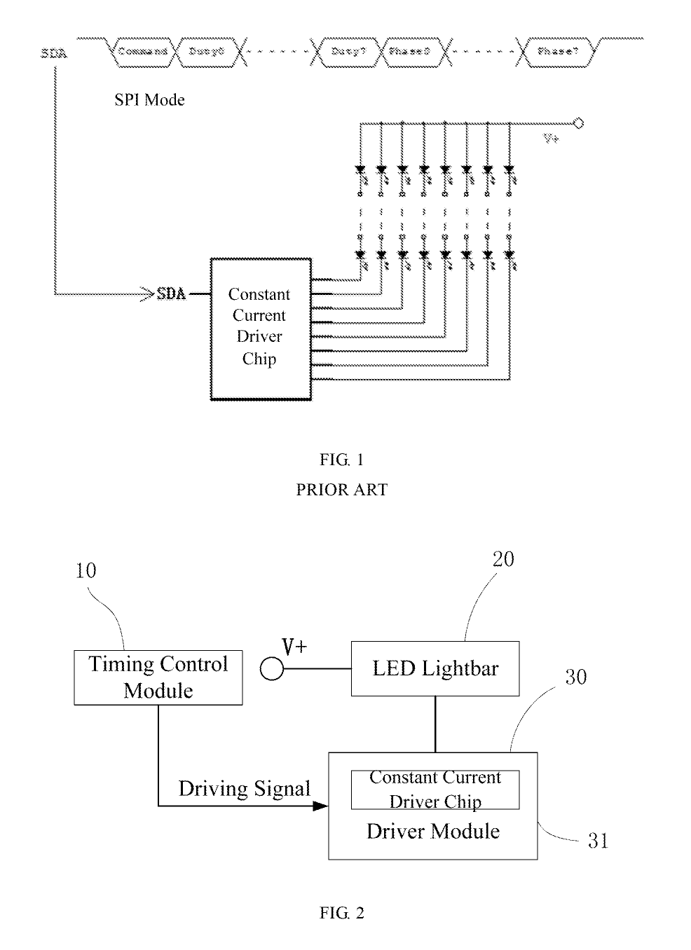

### DETAILED DESCRIPTION

As shown in FIG. 2, the present disclosure provides a liquid crystal display (LCD) device comprising a light emitting diode (LED) backlight driving circuit. The LED backlight driving circuit comprises a timing control module 10, an LED lightbar 20, and a driver module 30 coupled with an output end of the LED lightbar. The driver module 30 comprises at least one constant current driver chip 31 driving the LED lightbar to display. The timing control module successively outputs a driving signal to the constant current driver chip.

The driving signal comprises data units which are arranged in sequence, and each data unit storing a current duty and a phase delay of one LED lightbar. The constant current driver chip directly reads data of a corresponding data unit and then drives the LED lightbar to display.

In the present disclosure, because the driving signal is divided into data units which are arranged in sequence, each data unit storing the current duty and phase delay of one LED lightbar, namely data of a first LED lightbar is arranged in front of all the data of the LED lightbar when coding the driving signal, data of the current duty and phase delay of following LED lightbars are arranged in sequence, the constant current driver chip of the driver module may directly read the data of the current duty and phase delay, which belong to the data unit of the constant current driver chip, from the driving signals. Thus, the data of the current duty and the phase delay are transmitted to a corresponding chip channel in sequence without storing a large number of driving signals in advance and following complicated operations such as chip selection, decoding and the like, data storage space is reduced, and data processing mode is simplified, thereby saving hardware costs and design and development costs. In addition, because the constant current driver chips may control the LED lightbar by directly reading the driving signal, a plurality of same constant current driver chips are connected in series in accordance with a number of the LED lightbar, and commonality of material is increased.

The present disclosure will further be described in detail in accordance with the figures and the exemplary examples.

### Example 1

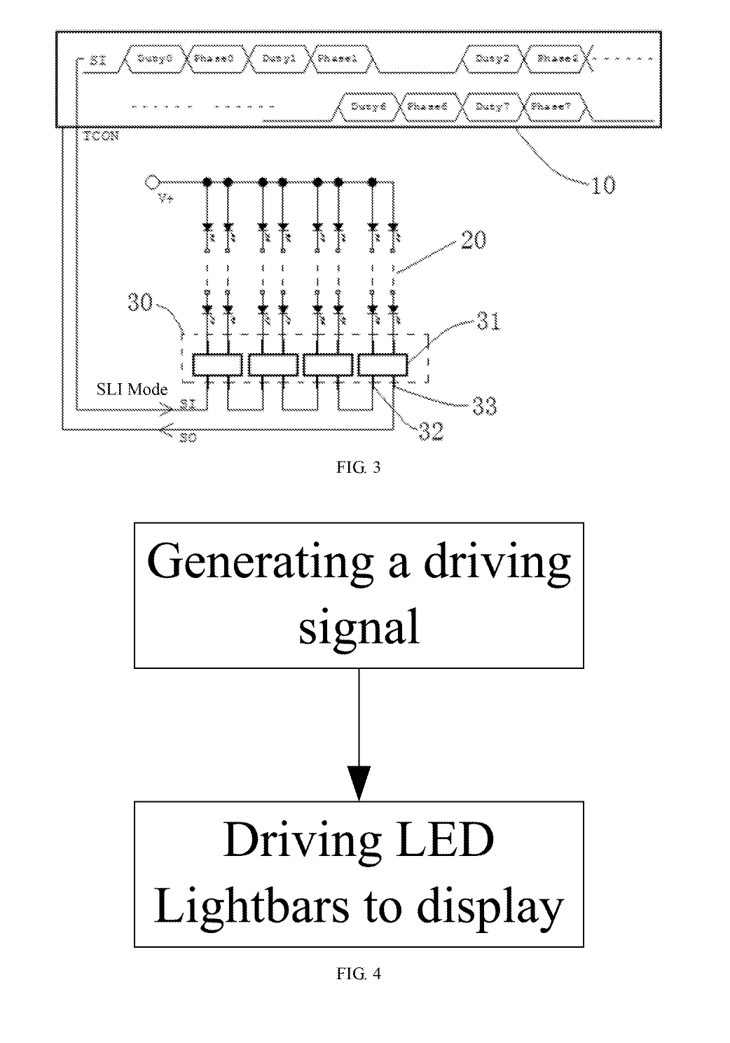

As shown in FIG. 3, an LED backlight driving circuit of a first example comprises a timing control module 10, an LED lightbar 20, and a driver module 30 coupled with an output end of the LED lightbar 20. The driver module 30 comprises at least one constant current driver chip 31 driving the LED lightbar 20 to display, and the timing control module 10 successively outputs a driving signal to the constant current driver chip 31. The driving signal comprises data units which are arranged in sequence, and each data unit storing a current duty and a phase delay of one LED lightbar 20. The constant current driver chip 31 directly reads data of a corresponding data unit and then drives the LED lightbar 20 to display.

The constant current driver chip 31 is configured with a signal input pin 32 and a signal output pin 33. The timing control module 10 is configured with a first signal line SI and a second signal line SO. A plurality of constant current driver chips 31 are arranged in the driver module 30, such as two, four, eight and the like, and the constant current driver chips 31 are connected in series. The signal input pin 32 of each constant current driver chip 31 is connected to a signal output pin 33 of a former constant current driver chip 31 or the first signal line SI. The signal output pin 33 of each constant current driver chip 31 is connected to a signal input pin 32 of a latter constant current driver chip 31 or the second signal line SO.

Each constant current driver chip 31 is connected to two LED lightbars 20. The driving signal further comprises a data packet, and the data packet comprises data units corresponding to two adjacent LED lightbars. In the example, the current duty and phase delay of each LED lightbar are transmitted to the LED lightbar in accordance with a preset order by a two-channel constant current driver chip 31, only data of two adjacent LED lightbars 20 are put in one data packet. Corresponding number of two-channel constant current driver chips 31 are collocated in accordance with a number of the LED lightbars 20, and then the LED backlight driven under three-dimensional (3D) pattern is achieved. Optionally, the present disclosure may select a constant current driver chip 31 having one channel or more than three channels.

In the example, the method of connecting a plurality of constant current driver chips 31 in series is used, where a serial lighting interface (SLI) data transmission interface mode is used between the timing control module 10 and the constant current driver chip 31, and the current duty and phase delay of each LED lightbar 20 are transmitted to the constant current driver chip 31 corresponding to the LED lightbar 20 in accordance with the preset order only by performing simple one-way data transmission. The method allows for flexible adjustment of a number of data unit in accordance with the number of the LED lightbar 20, simple data format, and high generality.

### Example 2

As shown in FIG. 4, a second example further provides a driving method of an LED backlight driving circuit of the present disclosure, comprising steps:

A: generating a driving signal;

a timing control module generates a driving signal, the driving signal comprises data units which are arranged in series, and each data unit storing a current duty and a phase delay of one LED lightbar; and

B: driving the LED lightbar to display;

a constant current driver chip of a driver module directly reads the current duty and phase delay of a corresponding data unit and then drives the LED lightbar to display.

The constant current driver chip may be a one-channel constant current driver chip, and may be a multi-channel constant current driver chip as well. A two-channel constant current driver chip is used in the example, namely each constant current driver chip is connected to two LED lightbars. In the example, the step A comprises: dividing the driving signals into at least one data packet, each data packet comprises data units corresponding to two adjacent LED lightbars. The current duty and phase delay of each LED lightbar are transmitted to each LED lightbar in accordance with the preset order by the two-channel constant current driver chip, only data of two adjacent LED lightbars are put in one data packet. Corresponding number of two-channel constant current driver chips are collocated in accordance with the number of the LED lightbars, and then the LED backlight driven under 3D pattern is achieved.

In the step B, a plurality of constant current driver chips may be arranged in the driver module, and the driving signal is transmitted to the constant current driver chip arranged in a final position from the constant current driver chip arranged in a beginning position in sequence. Each constant current driver chip reads the current duty and phase delay, which belong to the data unit of the constant current driver chip, from the driving signal, and then drives the LED lightbar to display. The method of connecting a plurality of constant current driver chips in series is used, the SLI data transmission interface mode is used between the timing control module and the constant current driver chip, and the current duty and phase delay of each LED lightbar are transmitted to the constant current driver chip corresponding to each LED lightbar in accordance with the preset order only by performing a simple one-way data transmission. The method allows for flexible adjustment of a number of data unit in accordance with the number of the LED lightbar, simple data format, and high generality.

In the step B, after all of the constant current driver chips receive the driving signal, the constant current driver chip drives the LED lightbar to display in accordance with the current duty and phase delay of respective data unit. After reading the driving signal, all of the constant current driver chips drive together the LED lightbar to display, thus all of the constant current driver chips achieve the data of the phase delay under same time benchmark, and all of the constant current driver chips separately drive respective LED lightbar to display after achieving the preset phase delay. Thus, the phase delay between different LED lightbars may not be affected by data transmission delay, thereby having great control accuracy, improving display effect, and increased three-dimensional image display qualities.

### Example 3

The example provides an LED backlight driving circuit using one constant current driver chip.

The LED backlight driving circuit comprises a timing control module, an LED lightbar, and a driver module coupled with an output end of the LED lightbar. The driver module comprises at least one constant current driver chip driving the LED lightbar to display. The timing control module successively outputs a driving signal to the constant current driver chip. The driving signal comprises data units which are arranged in sequence, and each data unit storing a current duty and a phase delay of one LED lightbar. The constant current driver chip directly reads data of a corresponding data unit and then drives the LED lightbar to display.

The constant current driver chip is configured with a signal input pin and a signal output pin. The timing control module is configured with a first signal line and a second signal line. The first signal line is coupled with the signal input pin of the constant current driver chip. The second signal line is coupled with the signal output pin of the constant current driver chip.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A light emitting diode (LED) backlight driving circuit, comprising:
a timing control module;
an LED lightbar; and
a driver module coupled with an output end of the LED lightbar; wherein the driver module comprises at least one constant current driver chip driving the LED lightbar to display, and the timing control module successively outputs a driving signal to the constant current driver chip;
the driving signal comprises data units which are arranged in sequence, and each data unit storing a current duty and a phase delay of one LED lightbar; the constant current driver chip directly reads data of a corresponding data unit and drives the LED lightbar to display using the data of the corresponding data unit.

2. The LED backlight driving circuit of claim 1, wherein each constant current driver chip is connected to two LED lightbars; the driving signal further comprises a data packet, the data packet comprises data units corresponding to two adjacent LED lightbars.

3. The LED backlight driving circuit of claim 1, wherein the constant current driver chip is configured with a signal input pin and a signal output pin, the timing control module is configured with a first signal line and a second signal line; the driver module comprises at least two constant current driver chips, and the constant current driver chips are connected in series; the signal input pin of each constant current driver chip is connected to the signal output pin of a former constant current driver chip or the first signal line; and the signal output pin of each constant current driver chip is connected to the signal input pin of a latter constant current driver chip or the second signal line.

4. The LED backlight driving circuit of claim 3, wherein each constant current driver chip is connected to two LED lightbars; the driving signal further comprises a data packet, and the data packet comprises data units corresponding to two adjacent LED lightbars.

5. The LED backlight driving circuit of claim 3, wherein the driver module comprises four constant current driver chips.

6. The LED backlight driving circuit of claim 5, wherein each constant current driver chip is connected to two LED lightbars; the driving signal further comprises a data packet, and each data packet comprises data units corresponding to two adjacent LED lightbars.

7. The LED backlight driving circuit of claim 1, wherein the constant current driver chip is configured with a signal input pin and a signal output pin, the timing control module is configured with a first signal line and a second signal line; the first signal line is coupled with the signal input pin of the constant current driver chip; and the second signal line is coupled with the signal output pin of the constant current driver chip.

8. A liquid crystal display (LCD) device, comprising:
a light emitting diode (LED) backlight driving circuit;
wherein the LED backlight driving circuit comprises a timing control module, an LED lightbar, and a driver module coupled with an output end of the LED lightbar; the driver module comprises at least one constant current driver chip driving the LED lightbar to display, and the timing control module successively outputs a driving signal to the constant current driver chip;
the driving signal comprises data units which are arranged in sequence, and each data unit storing a current duty and a phase delay of one LED lightbar; the constant current driver chip directly reads data of a corresponding data unit and drives the LED lightbar to display using the data of the corresponding data unit.

9. The liquid crystal display (LCD) device of claim 8, wherein each constant current driver chip is connected to two LED lightbars; the driving signal further comprises a data packet, and the data packet comprises data units corresponding to two adjacent LED lightbars.

10. The liquid crystal display (LCD) device of claim 8, wherein the constant current driver chip is configured with a signal input pin and a signal output pin, the timing control module is configured with a first signal line and a second signal line; the driver module comprises at least two constant current driver chips, and the constant current driver chips are connected in series; the signal input pin of each constant current driver chip is connected to the signal output pin of a former constant current driver chip or the first signal line, and the signal output pin of each constant current driver chip is connected to the signal input pin of a latter constant current driver chip or the second signal line.

11. The liquid crystal display (LCD) device of claim 10, wherein each constant current driver chip is connected to two LED lightbars; the driving signal further comprises a data packet, and the data packet comprises data units corresponding to two adjacent LED lightbars.

12. The liquid crystal display (LCD) device of claim 10, wherein the driver module comprises four constant current driver chips.

13. The liquid crystal display (LCD) device of claim 12, wherein each constant current driver chip is connected to two LED lightbars; the driving signal further comprises a data packet, and the data packet comprises data units corresponding to two adjacent LED lightbars.

14. The liquid crystal display (LCD) device of claim 8, wherein the constant current driver chip is configured with a signal input pin and a signal output pin, the timing control module is configured with a first signal line and a second signal line; the first signal line is coupled with the signal input pin of the constant current driver chip, and the second signal line is coupled with the signal output pin of the constant current driver chip.

15. A driving method of a light emitting diode (LED) backlight driving circuit, the LED backlight driving circuit comprising a timing control module, an LED lightbar, and a driver module coupled with an output end of the LED lightbar; the driver module comprising at least one constant current driver chip driving the LED lightbar to display, and the timing control module successively outputting a driving signal to the constant current driver chip; the driving signal comprising data units which are arranged in sequence, and each data unit storing a current duty and a phase delay of one LED lightbar; the constant current driver chip directly reading data of a corresponding data unit and driving the LED lightbar to display using the data of the corresponding data unit; the driving method comprising:
A: generating a driving signal by the timing control module, the driving signal comprises data units which are arranged in sequence, and each data unit storing the current duty and phase delay of one LED lightbar; and
B: directly reading the current duty and phase delay of the corresponding data unit and driving the LED lightbar to display by the constant current driver chip of the driver module.

16. The driving method of the light emitting diode (LED) backlight driving circuit of claim 15, wherein in the step B, the driver module comprises at least two constant current driver chips, and the driving signal is transmitted to the constant current driver chip arranged in a final position from the constant current driver chip arranged in a beginning position in sequence; each constant current driver chip reads the current duty and phase delay, which belong to the data unit of the constant current driver chip, from the driving signal, and then drives the LED lightbars to display.

17. The driving method of the light emitting diode (LED) backlight driving circuit of claim 16, wherein in the step B, after all of the constant current driver chips receive the driving signal, the constant current driver chip drives the LED lightbar to display in accordance with the current duty and phase delay of respective data unit.

18. The driving method of the light emitting diode (LED) backlight driving circuit of claim 15, wherein in the step A, the driving signal further comprises at least one data packet, and the data packet comprises data units corresponding to two adjacent LED lightbars; in the step B, each constant current driver chip is connected to two LED lightbars.

19. The driving method of the light emitting diode (LED) backlight driving circuit of claim 18, wherein in the step B, the driver module comprises at least two constant current driver chips, and the driving signal is transmitted to the constant current driver chip arranged in a final position from the constant current driver chip arranged in a beginning position; each constant current driver chip reads the current duty and phase delay of the data unit respectively corresponding to the constant current driver chip, and drives the LED lightbar to display.

20. The driving method of the light emitting diode (LED) backlight driving circuit of claim 19, wherein in the step B, after all of the constant current driver chips receive the driving signal, the constant current driver chip drives the LED lightbar to display in accordance with current duty and phase delay of a respective data unit.
